(19) United States
(12) Patent Application Publication
(10) Pub. No.: US 2022/0340163 A1
(43) Pub. Date: Oct. 27, 2022

(54) METHOD FOR OPERATING AN AT LEAST PARTIALLY AUTOMATED VEHICLE

(71) Applicant: Robert Bosch GmbH, Stuttgart (DE)

(72) Inventors: Alexander Geraldy, Hildesheim (DE); Christoph Thein, Hildesheim (DE); Silke Vogel, Bietigheim-Bissingen (DE); Uwe Wilbrand, Leutenbach (DE)

(21) Appl. No.: 17/649,051

(22) Filed: Jan. 26, 2022

(30) Foreign Application Priority Data
Apr. 21, 2021 (DE) 10 2021 203 994.4

(51) Int. Cl. B60W 60/00; B60W 40/06; H04W 4/44

(52) U.S. Cl. CPC B60W 60/001; B60W 40/06; H04W 4/44; B60W 2556/45; B60W 2556/35; B60W 2554/4041; B60W 2554/4046

(57) ABSTRACT

A method for supplying data for an at least partially automated vehicle. The method including: detecting the sensor data of an infrastructure; fusing the sensor data to form an environment model; wireless transmission of the environment model data to the at least partially automated vehicle; and wireless transmission of context data, relating to a location of the at least partially automated vehicle, to the at least partially automated vehicle, it being possible to evaluate the environment model data in a defined manner with the aid of the context data.

### CROSS REFERENCE

The present application claims the benefit under 35 U.S.C. 119 of German Patent Application No. 10 2021 203 994.4 filed on Apr. 21, 2021, which is expressly incorporated herein by reference in its entirety.

### FIELD

The present invention relates to methods for supplying data for an at least partially automated vehicle. The present invention further relates to a method for operating an at least partially automated vehicle. The present invention further relates to a system for supplying data for an at least partially automated vehicle. The present invention further relates to a computer program product.

### BACKGROUND INFORMATION

German Patent Application No. DE 10 2019 131 118 A1describes a system and method for evaluating the operation of vehicular environment detection systems.

German Patent Application No. DE 10 2017 220 402 A1 describes a method for communication between vehicles.

### SUMMARY

An object of the present invention is to provide an improved method for supplying data for an at least partially automated vehicle.

According to a first aspect of the present invention, the object may be achieved by a method for supplying data for an at least partially automated vehicle. In accordance with an example embodiment of the present invention, the method comprises the following steps:
detecting the sensor data of an infrastructure;
fusing sensor data to form an environment model;
wireless transmission of the environment model data to the at least partially automated vehicle; and
wireless transmission of context data, relating to a location of the at least partially automated vehicle, to the at least partially automated vehicle, it being possible to evaluate the environment model data in a defined manner using the context data.

Advantageously, this enables the vehicle to better evaluate the sensor data and to optimize the driving behavior. As a result, the vehicle is able to adapt its driving operation to non-optimal environmental conditions. This can significantly enhance the usability of the sensor data for the vehicle in an advantageous manner.

According to a second aspect of the present invention, the object may be achieved by a method for operating an at least partially automated vehicle. In accordance with an example embodiment of the present invention, the method comprises the following steps:
receiving data of an environment model generated from sensor data of an infrastructure;
receiving context data relating to a location of the vehicle concerning the environment and/or sensors of the infrastructure; and
initiating a driving behavior of the at least partially automated vehicle based on the environment model data evaluated using the context data.

According to a third aspect of the present invention, the object may be achieved by a device that is configured to execute the provided method(s).

According to a fourth aspect of the present invention, the object may be achieved by a system for supplying data for an at least partially automated vehicle. In accordance with an example embodiment of the present invention, the system comprises:
a fusion device for supplying an environment model generated from the sensor data of an infrastructure;
a context data device for supplying location-related context data;
the system being configured to wirelessly transmit the environment model data and the context data to an at least partially automated vehicle.

According to a fifth and sixth aspect of the present invention, the object may be achieved by a computer program product including program code to carry out the provided method when it runs on a provided electronic device or is stored on a computer-readable storage medium.

Advantageous developments of the method in accordance with the present invention are disclosed herein.

One advantageous development of the method of the present invention includes creating the environment model with the aid of a list of objects in the environment of the infrastructure. This generates a representation of the automated vehicle's environment using the fused sensor data.

Another advantageous development of the method of the present invention comprises the transmission of at least one of the following as context data: Sensor characteristic data of sensors, confidence value of the sensors, weather data, road condition data. This results in a plurality of context data options so that the vehicle is able to make more efficient use of the sensor data.

Another advantageous development of the method of the present invention provides for the context data to be supplied by a computing device.

Another advantageous development of the method of the present invention comprises supplying the context data and/or the environment model data by mobile telecommunication.

Another advantageous development of the method of the present invention comprises the transmission of the context data via geocasting. This is a locally limited version of mobile telecommunication, which provides an enhanced relationship between the sensor data and the context data.

Another advantageous development of the method of the present invention comprises transmitting the context data to the at least partially automated vehicle at a defined, lower data rate than the data of the environment model. This supports a high usage quality of the fused sensor data or the environment model. Advantageously, a usefulness of the fused sensor data may be significantly enhanced in this manner.

The present invention is described in detail below including further features and advantages on the basis of two figures. All features described or depicted form the subject matter of the present invention, by themselves or in any combination, regardless of their combination formulation or representation in the description or in the figures.

Disclosed features and advantages of the provided methods of the present invention are similarly derived from disclosed features and advantages of the provided device or the provided system of the present invention, and vice versa.

### BRIEF DESCRIPTION OF THE DRAWINGS

FIG. 1 shows a basic block diagram of a provided system for executing the provided methods, in accordance with an example embodiment of the present invention.

FIG. 2 shows a basic sequence of a specific example embodiment of the provided method of the present invention for supplying data for an at least partially automated vehicle.

### DETAILED DESCRIPTION OF EXAMPLE EMBODIMENTS

The term “automated vehicle” is herein used interchangeably with the terms “fully automated vehicle,” “autonomous vehicle,” and “semi-autonomous vehicle”.

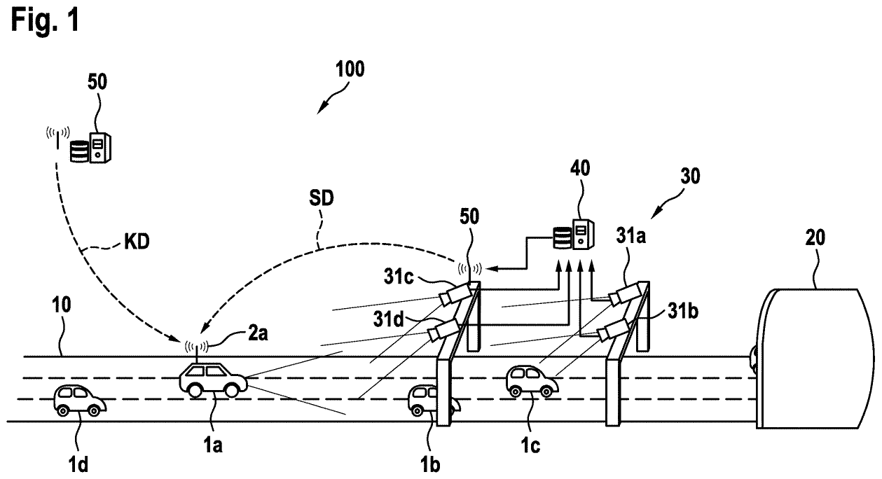

FIG. 1 shows a greatly simplified, basic block diagram of a provided system 100 for supplying data for an at least partially automated vehicle 1a . . . 1d. The method is described below in exemplary fashion for vehicle la, but it is understood that the provided method may also be used for additional or other vehicles 1a . . . . 1n.

FIG. 1 shows a vehicle 1a, which may be configured to be at least partially automated and travels in the center lane of a roadway 10 (e.g., an expressway). Vehicle 1a is approaching a tunnel 20. The figure also shows an IAD system, which enables infrastructure-assisted automated driving of vehicle 1a, the automated vehicle la being supported by the IAD system at critical points (e.g., tunnel entry, road intersection etc.). The IAD system may be particularly useful in scenarios where a sensor system of the automated vehicle la itself may not be sufficient for automated driving operation.

The IAD system comprises an infrastructure 30 having a plurality of sensors 31a . . . 31d, e.g. in the form of cameras, that detect the environment of vehicle la using sensor technology and transmit the detected camera data to a computing device 40 (e.g. located in the cloud), which fuses the camera data into environment model data. The environment model preferably comprises at least one object list, the object list including entries with data of the vehicles, pedestrians, bicyclists, static objects on the roadway etc. detected by sensors 31a . . . 31n. For example, the IAD system may be certified for a function in suitable boundary conditions, for instance in the form of parameters (e.g., temperature, humidity level, brightness, type of object, particle concentration in the air, etc.), in which the IAD system is able to function properly.

In the case of FIG. 1, the environment model comprises data relating to vehicles 1b, 1c and may also, depending on the range of sensors 31a . . . 31d, comprise data relating to vehicles 1a, 1d. The above-referenced data may be a distance measure and/or a speed measure and/or a size of the objects detected by sensors (e.g., classified as vehicles, pedestrians, trucks, static objects on the roadway (e.g., a toppled tree) etc.). As a result, the environment model supplies a list representation of the surroundings of vehicle 1a.

Additionally or as an alternative, sensors 31a . . . 31n may also be configured as radar sensors, lidar sensors, ultrasonic sensors etc. The fused camera data are transmitted wirelessly, as data of the environment model or the object lists, by way of an antenna device 50 to an antenna device 2a of vehicle la in the form of V2X (vehicle-to-everything) data. As a result, the data of the environment model may be used to expand the field of view generated by the vehicle sensor system of the automated vehicle 1a.

The present invention also provides for the wireless transmission of so-called “context data” KD to vehicle 1a, relating to a location of vehicle 1a, for example from an external server device 50. Context data KD are data that are able to provide additional descriptions of the surroundings detected by the IAD system's sensors. The context data KD are preferably supplied by infrastructure 30 using sensors 31a . . . 31d.

As an alternative, the context data KD may also be supplied by the external server device 50, it being possible for the external server device 50 to be operated, e.g., by a service provider (e.g., a weather service), which provides context data KD in the form of weather data (for instance, information relating to rain, fog, snowfall, temperature, icy roads, wet roads, risk of aquaplaning, etc.) in the region or in the environment of vehicle 1a. The context data KD may be transmitted to vehicle 1a by the server device 50 and/or the computing device 40, e.g., via mobile telecommunication (e.g., LTE). The local relation of the context data KD to the region for which the context data KD are intended may range from a few meters to a few kilometers. Vehicle 1a may thus advantageously be informed about the existence of fog even before it drives into the setting detected by sensors 31 a. . . 31n, which already enables vehicle 1a to adapt its driving behavior accordingly in advance.

Alternatively or in addition, the context data KD may also comprise information relating to a state of the sensor devices 31a . . . 31n. As a result, using the context data KD, vehicle 1a is thus able to correctly interpret or evaluate the data of the environment model or the fused sensor data SD in the form of the object lists and able to draw the suitable conclusions, e.g., regarding a further driving operation. For example, the system may be configured such that vehicle 1a decelerates and/or accelerates, and/or performs steering maneuvers, adjusts its distance from the preceding vehicle etc.

This effectively supports a safe driving operation of the at least partially automated vehicle 1a.

The data of the environment model or the fused sensor data SD are preferably transmitted to vehicle la in real time, i.e. in very short cycle times (e.g., in millisecond intervals), i.e. at a high data rate, whereas the context data KD are transmitted to vehicle 1a in larger time intervals or cycle times (e.g., in minute or hour intervals), i.e., at a lower data rate. For example, it is also possible that the context data KD are directly supplied by the computing device 40 together with the object lists.

In the manner explained, it is advantageous for vehicle 1a to receive information about the prevailing local conditions regarding the weather and/or the capability of the sensors in infrastructure 30 already prior to driving into a locally defined setting.

As a result, the sensor data SD, evaluated by the context data KD, enable the at least partially automated vehicle 1a to adapt its driving behavior to prevailing conditions, for example by reducing its speed, stopping, performing steering maneuvers, issuing warning signals etc.

An exemplary sequence of the provided method could be as follows:
1. Sensors 31a . . . 31n of the IAD system or the infrastructure 30 detect fog and report this finding to the computing device 40 in the cloud, which may be responsible for generating the context data KD.
2. The sensors 31a . . . 31n detect further objects and transmit them to the computing device 40 responsible for data fusion, which processes the sensor information into object lists and transmits these to vehicle 1a via V2X (vehicle-to-everything) communication at a transmission rate of 15 Hz for example.
3. The context data KD may be transmitted to vehicle 1a for example by geocasting (locally limited transmission of information) by mobile telecommunication in a defined cycle (e.g., every minute).
4. As a result, the context data KD is already available to vehicle 1a before it reaches the IAD system.
5. Vehicle 1a uses the data to determine an evaluation for itself, e.g. to establish to which extent it is able to use the object lists of the IAD system for its own driving strategy.

If there is no fog, vehicle 1a could use the object lists of the sensor data SD in the scope of a known functionality of the IAD system.

In this manner, based on the received data SD, KD, the at least partially automated vehicle 1a is to be able safely to determine the feasible uses of the sensor data SD with the aid of the context data KD. The sensor data are thus “evaluated” with the aid of the context data. If, for example, the fused sensor data or the environment model data, in combination with the context data KD, show prevailing fog and/or icy road conditions, it is determined that a certain speed of vehicle la is not permissible or safe. As a result, a device within the vehicle (e.g., an electronic vehicle control unit) makes the decision to reduce the speed of the at least partially automated vehicle 1a.

Using the example of tunnel 20 in FIG. 1, this process could be as follows:
Prior to entering tunnel 20, vehicle 1a learns from the context data KD which service is available and which restrictions for using the data of the environment model apply. This allows for adjusting the driving behavior of the automated vehicle 1a, for example by reducing its speed in foggy conditions.

When using the sensor data SD, the context data KD are used to “classify” the sensor data SD, for example in the following way:
What are the boundary conditions for using the fused sensor data SD?
How must the driving performance of vehicle 1a be adjusted to be able to safely use the fused sensor data SD?
To which extent may the sensor data detected by the vehicle itself be utilized in the given context?

The detection of foggy conditions may therefore prompt an adjustment of the driving operation of the at least partially automated vehicle 1a in such a way that it drives more cautiously from the outset or maintains larger distances from preceding vehicles. Furthermore, in the range of infrastructure 30 detected by sensors, the at least partially automated vehicle 1a is able to handle the confidence values transmitted in connection with the context data KD differently, make specific use of data generated by its own sensors (vehicle sensor system), react specifically to data of the environment model, etc.

For example, there may be a provision that the evaluation of the environment model data with the aid of the context data KD determines a confidence value of the fused sensor data SD to thus establish to what extent the fused sensor data of the infrastructure 30 or the IAD system may be “trusted”. For example, this may be useful in a case where it is communicated via the context data KD that one or more sensors 31a . . . 31n are damaged and/or have failed and/or are soiled.

An example for the context data KD would be a notification about the presence of icy road conditions, which significantly impacts the status of the permissible speed for vehicle 1a based on the received object lists and with consideration of safety aspects.

An operation of sensors 31a . . . 31n of infrastructure 30 may thus be expanded advantageously, since its operation may be sustained even in unfavorable conditions, e.g. outside of the above-referenced boundary conditions for proper operation.

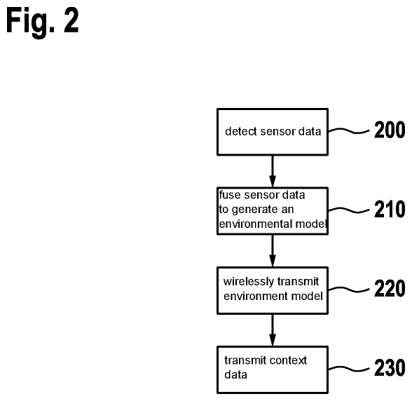

FIG. 2 shows in highly schematic fashion, a basic sequence of a provided method.

In a step 200, sensor data SD of an infrastructure 30 are detected.

In a step 210, the sensor data SD are fused to generate an environment model.

In a step 220, the environment model data is wirelessly transmitted to the at least partially automated vehicle 1a . . . 1n.

In a step 230, the context data KD, relating to a location of the at least partially automated vehicle 1a . . . 1n, are transmitted wirelessly to the at least partially automated vehicle 1a . . . 1n, it being possible to evaluate the environment model data in a defined manner with the aid of the context data KD.

An electronic control unit may be advantageously provided in vehicle 1a to receive the fused sensor data SD and the context data KD and to subsequently carry out an evaluation of the fused sensor data SD with consideration of the context data KD, followed by planning or implementing a driving strategy for vehicle la in the above-described manner. In this context, the electronic control unit of the at least partially automated vehicle determines a driving operation or initiates a driving mode.

The method of the present invention may be advantageously implemented as a software, which may, for example, run on the provided device. This supports a simple adaptability of the method. The software of the device may conceivably be at least partially cloud-based.

One skilled in the art may modify and/or combine the features of the present invention in a suitable manner without deviating from the essence of the present invention, in view of the disclosure herein.

What is claimed is:

1. A method for supplying data for an at least partially automated vehicle, the method comprising the following steps:
detecting sensor data of an infrastructure;
fusing the sensor data to form an environment model;
wirelessly transmitting data of the environment model to the at least partially automated vehicle; and
wirelessly transmitting context data, relating to a location of the at least partially automated vehicle, to the at least partially automated vehicle, the at least partially automated vehicle being able to evaluate the data of the environment model in a defined manner using the context data.

2. The method as recited in claim 1, wherein the environment model is generated using a list of objects in surroundings of the infrastructure.

3. The method as recited in claim 1, wherein at least one of the following is wirelessly transmitted as the context data:
sensor characteristic data of sensors, confidence value of the sensors, weather data, road condition data.

4. The method as recited in claim 1, wherein the context data are provided by a computing device.

5. The method as recited in claim 1, wherein the context data and/or the data of the environment model are wirelessly transmitted via mobile telecommunication.

6. The method as recited in claim 5, wherein the context data are wirelessly transmitted via geocasting.

7. The method as recited in claim 1, wherein the context data are wireless transmitted to the at least partially automated vehicle at a defined, lower data rate than the data of the environment model.

8. A method for operating an at least partially automated vehicle, the method comprising the following steps:
receiving data of an environment model generated from sensor data of an infrastructure;
receiving context data relating to a location of the vehicle concerning an environment of the infrastructure and/or sensors of the infrastructure; and
initiating a driving behavior of the at least partially automated vehicle based on the data of the environment model evaluated using the context data.

9. The method as recited in claim 8, wherein the at least partially automated vehicle executes at least one of the following as a function of the data of the environment model evaluated using the context data: evaluating a performance capability of the vehicle sensor system, adjusting a speed, performing a steering maneuver, adjusting a distance from a preceding vehicle.

10. A vehicle control unit configured to operate an at least partially automated vehicle, the vehicle control unit configured to:
receive data of an environment model generated from sensor data of an infrastructure;
receive context data relating to a location of the vehicle concerning an environment of the infrastructure and/or sensors of the infrastructure; and
initiate a driving behavior of the at least partially automated vehicle based on the data of the environment model evaluated using the context data.

11. A system to supply data to an at least partially automated vehicle, the system comprising:
a fusing device configured to generate an environment model from sensor data of an infrastructure; and
a context data device configured to supply location-related context data;
wherein the system is configured to wirelessly transmit data of the environment model and the context data to an at least partially automated vehicle.

12. A non-transitory computer-readable storage medium on which is stored a computer program for supplying data for an at least partially automated vehicle, the computer program, when executed by a computer, causing the computer to perform the following steps:
detecting sensor data of an infrastructure;
fusing the sensor data to form an environment model;
wirelessly transmitting data of the environment model to the at least partially automated vehicle; and
wirelessly transmitting context data, relating to a location of the at least partially automated vehicle, to the at least partially automated vehicle, the at least partially automated vehicle being able to evaluate the data of the environment model in a defined manner using the context data.

13. A non-transitory computer-readable storage medium on which is stored a computer program for operating an at least partially automated vehicle, the computer program, when executed by a computer, causing the computer to perform the following steps:
receiving data of an environment model generated from sensor data of an infrastructure;
receiving context data relating to a location of the vehicle concerning an environment of the infrastructure and/or sensors of the infrastructure; and
initiating a driving behavior of the at least partially automated vehicle based on the data of the environment model evaluated using the context data.
